(19) United States
(12) Patent Application Publication
(10) Pub. No.: US 2026/0347108 A1
(43) Pub. Date: Nov. 5, 2026

(54) AUTOMATIC STORAGE SYSTEM AND METHOD FOR ACCURATELY DETERMINING THE POSITION OF STORAGE ITEMS

(71) Applicant: Kardex Produktion Deutschland GmbH, Neuburg/Kammel (DE)

(72) Inventors: Rolf Jaspers, Lampertheim (DE); Andreas Ößwein, Offenbach (DE)

(21) Appl. No.: 19/109,709

(22) PCT Filed: Dec. 20, 2023
(86) PCT No.: PCT/EP2023/087109

§ 371 Date: Mar. 7, 2025

(30) Foreign Application Priority Data
Dec. 20, 2022 (DE) 10 2022 134 215.8

(51) Int. Cl. B65G 1/137

(52) U.S. Cl. CPC B65G 1/137; B65G 2203/0233; B65G 2203/0283; B65G 2203/0291

(57) ABSTRACT

The invention relates to an automatic storage system (1 ), in particular a storage lift, with at least one storage and/or retrieval point (14) for stored items (11). Solutions from the prior art are expensive and require a lot of computing power. These solutions are improved in that the automatic storage system (1) has at least one detector (24) designed to determine a position of the stored item (11) in the automatic storage system (1) and to output a position signal (24a) representing the position of the stored item (11), wherein the detector (24) is further configured to output a time stamp (24b) with the position signal (24a) that is representative of a time (t₀) of generation of the position signal (24a).

### REFERENCE TO PENDING PRIOR PATENT APPLICATIONS

This patent application is a 371 national stage entry of pending prior International (PCT) Patent Application No. PCT/EP2023/087109, filed 20 Dec. 2023 by Kardex Produktion Deutschland GmbH for AUTOMATIC STORAGE SYSTEM AND METHOD FOR ACCURATELY DETERMINING THE POSITION OF STORAGE ITEMS, which patent application, in turn, claims benefit of German Patent Application No. 10 2022 134 215.8, filed 20 Dec. 2022.

The two (2) above-identified patent applications are hereby incorporated by reference.

### FIELD OF THE INVENTION

The invention relates to an automatic storage system having at least one storage and/or retrieval point for storage items, and a conveying device for transporting the storage items at least to the at least one storage and/or retrieval point, a method for calculating at least one position of storage items in an automatic storage system, and a computer program product and a computer-readable data medium for carrying out the method.

### BACKGROUND OF THE INVENTION

Such an automatic storage system may be designed as an order picking device, a high rack warehouse, or in the simplest case as an automatic storage rack. In each of these designs, storage items, i.e., stored goods, are transported back and forth between storage places and the storage and/or retrieval point by one or more conveying devices of the storage system. The transport of the storage items in the automatic storage system takes place automatically.

During storage of the storage items, the storage items are transported from the storage point to their respective storage place, and during retrieval are transported from their respective storage place to the retrieval point. The storage point and the retrieval point may be identical, and may be designed as a service opening, for example. In this case, the storage items may be stored and also retrieved at one location. However, the storage point and the retrieval point may be situated spatially apart from one another. In this case, the storage of the storage items takes place at a different location than the retrieval. A storage system may have any number of storage and/or retrieval points.

The storage items may be stored goods, or stored goods carriers that carry stored goods and either remain in the storage system or, together with the stored goods, are stored and/or retrieved via the storage and/or retrieval point(s).

Present storage systems, as used in particular for order picking, must allow high rates of access to the storage items. With such high access rates, unnecessary waiting times at the storage and/or retrieval points result in high costs. These waiting times arise when the storage item must be awaited for the retrieval, or when the conveying device must be awaited for the storage.

### SUMMARY OF THE INVENTION

Consequently, the object underlying the invention is to avoid unnecessary waiting times for automatic storage systems.

A further aspect of the present invention is the exact positioning of the stored good or stored goods carrier in the automatic storage system, for example in the lift shaft. Furthermore, the invention may also be applied to other positioning tasks for transport movements in a storage system.

This object is achieved on the one hand by an automatic storage system having at least one storage and/or retrieval point for storage items, having at least one detector, and having a conveying device for transporting the storage items at least to the at least one storage and/or retrieval point, the detector being designed to detect a position of the conveying device and to output a position signal that is representative of the detected position of the conveying device, the detector being further designed to output a time stamp, with the position signal, that is representative of the time of detection of the position of the conveying device.

On the other hand, this object is achieved by a method for detecting the position of a conveying device for transporting storage items in an automatic storage system, the method comprising the following steps: detecting a position of the conveying device in the storage system while the conveying device is moving; generating a time stamp that is representative of the time of detection of the position of the conveying device; and providing the position signal together with the time stamp.

The invention further relates to a computer program product that includes commands which, when the computer program product is executed by a computer, prompt the computer to carry out the method according to the invention, and to a computer-readable data medium on which such a computer program product is stored.

The above approach allows unnecessary waiting times to be avoided during the storage and/or retrieval, since, based on the time of the position measurement which is now accurately determined by the time stamp, on the one hand the arrival times of the conveying device at a certain location, for example a storage place or a storage and retrieval point, and on the other hand the position at any given point in time, may be more accurately determined.

In conventional storage systems, a time period, not exactly determined, in the range around 10 ms up to several times 10 ms may elapse between a query of the detector and a completed position calculation. The exact duration of this time period is a function, for example, of the present computer utilization and the volume of the data traffic at that moment. At the end of this time period, the calculated position no longer matches the actual position of the conveying device because the conveying device has undergone further movement. To obtain the most accurate position information possible, in automatic storage systems it is therefore common to use costly components having so-called reaction modules with low latency, bus systems having a rapid transfer rate, and interrupt controllers and/or control devices with high computing power.

Due to outputting the time stamp together with the position signal, such costly components may be dispensed with, since with the approach according to the invention, when the position signal has been completely transferred to a receiver, and how long the further processing of the position signal lasts, are irrelevant. Any delay in the transfer and evaluation of the position signal may be mathematically compensated for by use of the time stamp.

The invention may be enhanced with the following refinements, which in each case are advantageous alone and arbitrarily combinable with one another. The refining features discussed below may be used without distinction for the automatic storage system, the method, and the computer program product. If a method feature is involved, the device is readily designed to carry out the method step. Conversely, a device component may also be part of the method.

In one preferred embodiment, the detector may be designed to detect the position of the moving conveying device in the storage system.

The approach according to the invention, strictly as an example and without being limited thereto, may allow exact positioning of a stored goods carrier or a lift before the stored goods carrier is transferred to the storage places or into the service opening (storage and/or retrieval point). The allowed, i.e., possible, positioning tolerances may be +/−1 mm with respect to the target position. Since the control is not discontinued via interrupts as in the prior art, the approach according to the invention provides more cost-effective control.

The exact positioning may be triggered and/or controlled by a sensor event. One example of such a sensor event is the provision of a position signal that can be represented by an integral or an edge, or that can be generated by integration or occurrence of an edge. The position signal may also be a combination of an integral and an edge.

According to a first advantageous embodiment, the position of the conveying device may be detected while it is transporting at least one storage item. In this way, it is possible to accurately determine the position of the storage item after evaluation of the position signal has taken place, as well as the arrival time of the at least one storage item at a given location.

The detector may be designed to only, i.e., exclusively, detect the position of the conveying device. Detecting only the position of the conveying device is advantageous in particular when the conveying device during storage has transported the storage items to the storage place, or during retrieval has transported the storage items to the storage and/or retrieval point, and is subsequently moved to some other position in the automatic storage system. In this case, the conveying device travels empty or partially loaded to the other position. Measuring the position of the conveying device enables a prediction of when it arrives at the other position, and allows a user or a machine to adapt his/her/its work processes.

In a further advantageous refinement, the storage system, in particular the detector, may be designed to determine whether a stored good and/or a stored goods carrier is positioned on the conveying device. This embodiment may be further enhanced by designing the detector to alternatively or additionally determine the position of a storage item. This is advantageous during storage of stored goods, i.e., during transport of stored goods to a storage location or during retrieval of stored goods, i.e., during transport of stored goods to the storage and/or retrieval point. The position of the conveying device may be additionally determined and used for controlling the conveying device. The storage system may be further designed to select whether the position of the conveying device, of the stored goods carrier, or of the stored good is detected. The selection is preferably made based on whether a stored good and/or a stored goods carrier is present on the conveying device.

For this purpose, in one possible embodiment the automatic storage system may be designed to determine a position of the stored good based on a position assignment and the position of the conveying device. The automatic storage system may alternatively be designed to read out the position assignment from a memory in which the position assignment has been previously stored. In another embodiment, the position assignment may be determined or detected by the storage system. The position assignment may be representative of a position and/or an alignment or orientation of stored goods on a stored goods carrier. In addition, the position assignment may alternatively or additionally be representative of a position of the stored goods carrier on or at the conveying device. The storage system, in particular the data processing device, may thus be designed to determine a relative position of the stored good on the stored goods carrier and/or a relative position of the stored goods carrier on the conveying device, based on the position assignment. The storage system is further designed to determine from these relative positions, with knowledge of the position of the conveying device, the position of the stored goods carrier and/or of the stored good. In one embodiment, the data processing device may be designed to receive and/or further process the position assignment.

At least one stored goods detector may be provided in the automatic storage system for determining the relative positions. The stored goods detector preferably operates in a contactless manner, and may be a photoelectric barrier, a light curtain, a light sensor, a magnetic sensor, or an ultrasonic or lidar sensor, or may have a camera.

Alternatively or additionally, the detector may be designed to distinguish from one another the conveying device, the stored goods carrier, and a stored good situated thereon. Thus, in a further embodiment, in addition to the position signal an object signal may be generated and/or transmitted which is representative of the type of object whose position has been determined by the detector.

For this purpose, the detector may be designed to detect position markings that are characteristic of the conveying device, the stored goods carrier, and/or a stored good situated thereon.

For example, in one embodiment the position markings may be barcodes, QR codes, a hole pattern or color pattern, or in a simple case, specific patterns or shapes that can be recognized by the detector and assigned to an object. Optical detectors, laser scanners, or detectors having a camera may be used for this purpose. In other embodiments, the type of object whose position is determined by the detector may be transferred by an RFID transponder. A detector equipped in this way may thus include an RFID reader module.

In a further advantageous embodiment, it may be provided that the position of the conveying device is detected on the way to one of the at least one storage and/or retrieval points. This detection may in particular take place regardless of whether the conveying device is transporting at least one storage item. In this embodiment, a position signal and a time stamp may be used to accurately predict the arrival time of the conveying device at the storage and/or retrieval point. Further storage and/or retrieval steps may thus be precisely synchronized with the arrival of the conveying device.

Exact positioning of a stored goods carrier or of a stored good situated thereon may be necessary, for example, due to elongation of a toothed belt. In particular for large equipment, during transport of heavy stored goods or when environmental influences are present that may cause such elongation, only rough positioning is possible with a trained drive motor, since this elongation has not been learned in the training phase.

The above-mentioned elongation may also occur with other traction mechanisms, for example chains, cables, or bands. In the following discussion, only belts are considered for the sake of brevity. However, the statements apply for all traction mechanisms in which elongation can occur, in particular also for chains, cables, and bands.

If such elongation is not taken into account, the position of the stored goods carrier is not precisely determined, since the position of the stored goods carrier without elongation at time t0 x(t0) cannot be transferred to the position of the stored goods carrier at time t1 or calculated, due to the fact that the elongation causes a temporal delay of the stored goods carrier. Thus, for the position subject to elongation, the expression x′, x′(t1≠t0)≠x(t1≠t0) applies. The necessary error correction due to the elongation may be made, for example, by adding a correction value Δt, so that x′(t1)=x(t1+Δt) applies.

Strictly as an example, the stored goods carrier may be moved in the lift shaft at three different speeds. The stored goods carrier may be moved between two respective sensor events at an approximately constant speed. The sensor events, by way of example and without being limited thereto, may be a signal edge. In particular, multiple, preferably equidistant, sensor events may be generated along a transport path, for example in a grid spacing from the observer.

Thus, the stored goods carrier may be moved at the normal speed (generally >1 m/s) up to the next to last edge of the position signal, and then decelerated to approximately 0.03 m/s. At the last signal edge before the target position, the stored goods carrier can approach the target position at an even lower, defined speed, for example 0.005 m/s. A stopping distance during the last delay is then small compared to the required positional accuracy, so that it is negligible for the positioning.

In one embodiment, the automatic storage system may have multiple measuring points at certain locations; for example, a strut that is situated just before and/or after the stowing angle may be associated with each stowing angle pair (the stowing angle pairs may be provided in the grid spacing, and represent possible stowing positions in the storage lift). Likewise, multiple stowing positions may be provided between two neighboring struts.

A first sensor signal may be generated at such a strut. The distance between two neighboring struts may specify a maximum value for the allowable elongation of the belt.

In a further embodiment, edge detection may be activated upon recognition of the first sensor signal. This may be enabled, for example, by adding a further sensor. When the stored goods carrier is further moved, the further sensor may be designed to recognize when the stored goods carrier reaches an edge of the stowing angle and/or a strut, and to generate a further sensor event. The speed of the stored goods carrier may be reduced as soon as the edge has been recognized. The movement of the stored goods carrier with respect to the target position may thus take place at a lower speed, beginning with the edge detection.

The elongation may occur in particular with large accelerations. Such elongation may be negligible at constant speeds and insignificant changes in the speed, so that one advantage of the present invention may thus lie in exact fine positioning on the target position toward the end of the travel.

The more accurate position determination allows travel at higher speeds just before reaching the target position, compared to the prior art. Several seconds may thus be saved in each stowing movement, and the storage system may be utilized in a more rapid and time-saving manner.

In addition, the automatic storage system may be designed to calculate and/or output, as a function of the position signal and the time stamp, a position of the conveying device or of a storage item that is transported by the conveying device at the point in time that is represented in the time stamp, at a different time than the point in time that is represented in the time stamp. The other point in time may be only a short time after the point in time represented in the time stamp, for example less than 5 seconds or even less than only 2 seconds or less than 1 second. An output is understood to mean provision of data, for example the position, in particular by the data processing device, for access from the outside, and the actual output of the data via an output interface.

The automatic storage system may be designed, for example, to calculate and/or output a target position of the conveying device as a function of the position signal and the time stamp. Alternatively or additionally, the automatic storage system may be designed to calculate and/or output a target position of a storage item, transported by the conveying device at the point in time in the time stamp, as a function of the position signal and the time stamp.

The target position is a position which the conveying device and/or a storage item that is transported by the conveying device at the time of detection of the position of the conveying device will presumably occupy at a later time than the point in time that is represented in the time stamp. In both embodiments, the positions of the conveying device and/or of the storage item at the later point in time may be calculated in advance. The calculation of the target position allows a prediction of what point in time the storage item will arrive at a predetermined location, i.e., will be transported to the predetermined location by the conveying device of the automatic storage system.

Such a prediction allows, for example, calculation of a remaining time until the conveying device, and/or the storage item that is transported by the conveying device at the time of detection of the position of the conveying device, arrives at a predetermined location in the automatic storage system, preferably at or in the at least one storage and/or retrieval point, and generation and/or provision and/or outputting of a remaining time signal that represents the remaining time. The remaining time may be optically and/or acoustically represented or output by the automatic storage system, so that, for example, a user or a machine can adapt his/her/its work processes to the indicated remaining time. The remaining time is a temporal difference between a first point in time at which the target position of the conveying device and/or of the storage items is reached, and a second point in time at which the provision and/or output of the actual position takes place.

When storage and/or retrieval take(s) place automatedly, for example by means of a robot, a prediction of the position of the conveying device and/or of the storage item that is transported by the conveying device at the time of detection of the position of the conveying device allows efficient, time-optimized control of the robot, since the point in time at which the conveying device, and/or the storage item that is transported by the conveying device at the time of detection of the position of the conveying device, will arrive at a predetermined location, for example the storage and/or retrieval point, can be calculated. This allows the robot to arrive at the predetermined location simultaneously or synchronously with the conveying device or the storage items that are transported by the conveying device.

Alternatively or additionally, an actual position of the conveying device and/or of a storage item that is transported by the conveying device at the time of detection of the position may be calculated and/or output based on the time stamp and the position signal. The actual position is the position at the exact point in time at which this position is calculated and/or output in particular by the data processing device. In the actual position, delays due to the transfer and processing of the position signal and the time stamp are thus compensated for. The transfer times may be known and/or stored in the storage system.

In a further embodiment, any transfer times that follow after the calculation and/or output of the target or actual position and delay the further processing of the information concerning the actual position may be considered in advance by the automatic storage system and/or may be included in the calculation of the actual position via precompensation.

The automatic storage system may preferably include a timer module for generating a time signal and/or a timer input for supplying a time signal. Such an internal or external time signal may serve as a timer, and allows determination of points in time, for example the point in time of the position determination by the detector, or the point in time of the position calculation based on the time stamp and the position signal, and/or time periods, for example the time period between the point in time represented in the time stamp and the point in time of the calculation of the position. It is thus possible to temporally synchronize, retrospectively or prospectively, a movement of the conveying device and/or of the storage items that are transported by the conveying device.

The automatic storage system may have a data processing device that is designed to calculate and/or detect the position of the conveying device, and/or of a storage item that has been transported by the conveying device at the point in time that is represented in the time stamp, at a different time than the point in time that is represented in the time stamp. The data processing device may be a computer, for example. In one embodiment, the data processing device is designed to control the conveying device. The data processing device may also have a storage management system in which a storage item is associated with a storage component, for example a storage place, with the conveying device, and/or with a storage and/or retrieval point as a function of where the storage item is present at that moment. The timer module may be part of the data processing device.

The detector may be designed to automatically request the time signal when it detects the position of the conveying device and/or of a storage item that is transported by the conveying device, or determines that the conveying device and/or a storage item that is transported by the conveying device has reached the position of the detector. The detector is preferably designed to generate the time stamp as a function of the time signal.

The position signal of the at least one detector may have a rising or falling signal edge that represents the reaching of a predetermined position by an object, for example the conveying device or a storage item that is transported by the conveying device. The rising or falling signal edge may be provided and/or encoded together with the time stamp. In other embodiments, other characteristic points in the position signal may be used which are determined, for example, by a threshold value module, an increase module (first derivative of the curve of the position signal), or an inflection point module (second derivative of the curve of the position signal).

According to one advantageous embodiment, movement data may be provided by the automatic storage system. The automatic storage system may also be designed to calculate, based on the movement data, a position of the storage item at a different time than the point in time that is represented in the time stamp. The movement data may be stored, for example, in an electronic memory of the automatic storage system, in particular the data processing device.

The movement data may include at least speed data and/or acceleration data, for example along a transport path of the storage item or of the conveying device, or may be representative of a speed and/or acceleration profile, for example of the conveying device. For example, the movement data may be representative of a speed profile between the location of detection of the position of the conveying device or of an object that is transported by the conveying device at the time of the position detection, and a storage and/or retrieval point. This speed profile may be predefined for controlling the movement of the conveying device, including possible deceleration and/or acceleration processes. The speed of the conveying device may then be controlled or regulated based on the predefined speed profile. In addition, this speed profile allows the location of the conveying device and/or of a storage item that is transported by the conveying device at the point in time that is represented in the time stamp to be calculated more accurately at a time that is different from the point in time represented in the time stamp.

In one embodiment, the movement data may be detected, for example, by monitoring the motor current and/or by control signals to the conveying device. In one embodiment, the detector may for example be integrated into the conveying device. The detector may be designed to continually output a signal that is representative of the position of the conveying device, for example in order to control the conveying device. The temporal pattern of such a signal that represents the position of the conveying device may be representative of the movement data.

Such a detector may, for example, at the same time be integrated into the controller of the conveying device, and in particular may supply position data that are used for controlling the conveying device. The detector may also have a position measuring device, for example an incremental or absolute position sensor. In one embodiment, the detector may be a rotation angle sensor, for example, whose detected rotation angle is a function of the position of the conveying device in the automatic storage system.

The position of the conveying device may be measured and transferred in particular at predefined time intervals, for example with a predefined clocking. The predefined time intervals may be a function of a desired accuracy of the position of the conveying device and a maximum speed of the conveying device. The predefined time intervals may alternatively or additionally be a function of the modulation rate (units in bauds) of the selected transfer technology and may be correspondingly adaptable.

Each position signal generated in the predefined time intervals is provided with a time stamp. This allows any delay in the transfer and/or evaluation of the individual position signals to be mathematically compensated for in a calculated position profile by use of the particular associated time stamp.

The automatic storage system may thus be designed to control a speed or acceleration of the conveying device as a function of the calculated position profile of the conveying device.

The detector may be designed to generate or output the position signal as a function of a position of the conveying device and/or of a storage item that is transported by the conveying device. For example, the position signal may be output and/or generated when the conveying device or a storage item that is transported by the conveying device is situated at a predetermined position in the storage system. This position may correspond to the position of the detector.

In particular, the detector may also be an IO-Link detector, i.e., a detector that may be connected to actuators and controllers via a standardized connection to an IO-Link. The use of IO-Link technology offers the advantage that it may be used regardless of a field bus that is employed, and is thus universally usable. In addition, bidirectional communication is possible using very simple wiring.

When a storage item is conveyed in succession by multiple conveying devices, their movement data may in each case be provided and taken into account in the position calculation.

The automatic storage system may in particular include a storage lift or be a storage lift. In such a storage lift, stored goods carriers with stored goods situated thereon as storage items may be moved between the storage and/or retrieval point and a storage place. The storage places for the stored goods carriers are situated opposite one another and above one another with respect to a conveyor shaft of the storage lift. The conveying device may be situated in the conveyor shaft.

In particular, the storage lift may have two storage racks, between which the conveyor shaft is situated. In particular, a stored goods carrier may move along the conveyor shaft at a speed that may be assumed to be approximately constant, the stored goods carrier being decelerated upon reaching the storage place and/or upon reaching the storage and/or retrieval point, and accelerated when leaving the storage and/or retrieval point and/or the storage place.

The detector is advantageously stationarily situated in the automatic storage system, for example at a location along a transport path for the conveying device and/or storage items that are transported by the conveying device. The detector may be situated in the storage lift, in particular between the two storage racks in or at the conveyor shaft.

The automatic storage system may also be a paternoster lift, a horizontal carousel, a vertical carousel, or a small parts warehouse or high rack warehouse or some other storage system with an aisle conveyor.

The storage system may have one or more storage facilities, for example storage lifts, carousels, or paternoster lift systems. In addition, the storage system may have one or more automatic conveyor belts and automatic handling systems, for example robots. The conveyor belts may connect multiple storage facilities to one another. The at least one detector may be situated at any desired location in such a storage system, for example at a conveyor belt or in a storage facility.

In one embodiment, the automatic storage system may include only one individual storage facility, for example a storage lift, a carousel, or a paternoster lift system. In such a case, the detector is preferably situated in the one storage facility.

In a further advantageous embodiment, two, three, or more detectors are situated along the transport path. The detectors are preferably spaced apart from the service opening and from the storage place. This has the advantage that, despite a delay time, the position of the storage item can be determined before it reaches the storage place or the storage and/or retrieval point. If the detector is situated directly at the storage place or directly at the storage and/or retrieval point (i.e., at the service opening), there may be a risk that the remaining time until reaching the storage location or the storage and/or retrieval point is less than the delay resulting from the transfer and processing of the position signal and the time stamp. This has the drawback of the conveying device and/or storage items transported by the conveying device already arriving at its/their target position before this has been calculated and/or output. This may result in unnecessary waiting times and thus, increased operating costs.

The detector may preferably be situated at a conveying device that is movably provided in the automatic storage system, or at a retaining element, immovably provided in the automatic storage system, on the transport path of the conveying device and/or of the storage items that are transported by the conveying device, or may have a two-part design, with a detector element situated at the movable conveying device and a trigger element situated at the immovable retaining element, or vice versa.

The at least one detector is preferably a detector that operates in a contactless manner. However, the detector may also have a mechanically actuatable switch that is actuated and generates the position signal when the position to be detected is reached. A detector that operates in a contactless manner may have a photoelectric barrier, a light curtain, a light sensor, a magnetic sensor, an ultrasonic or lidar sensor, and/or a camera.

Strictly as an example and without being limited thereto, the detector may have a magnetic field sensor and a magnet. For generation of the position signal, it is irrelevant whether the magnetic field sensor or the magnet is situated at a moving element in the automatic storage system. In the simplest case, the magnetic field sensor may represent a coil or may also include a Hall sensor. The detector may also have a photoelectric barrier.

In a detector that has a two-part design, the detection element may be designed to provide and/or output the position signal when the trigger element is detected. The trigger element may be designed to prompt the detection element to output the position signal. In one embodiment, the position signal is output only when the trigger element is in a predetermined position relative to the detection element.

If the detection element is movably provided in the automatic storage system, two or more trigger elements, each spaced apart from one another, may be provided along the transport path. This allows generation of a sequence of two or more position signals with different time stamps. Since the distances between the two or more trigger elements are known, the speed of the conveying device and/or of the storage items that are transported by the conveying device may thus be determined from the time stamps, or may be verified by comparison with stored movement data.

The storage item (for example, a stored good situated on a stored goods carrier) may pass through a storage and/or retrieval opening of the storage and/or retrieval point during storing and retrieval, it being possible for the detector or a further detector to be situated directly at or in the storage and/or retrieval opening.

The method may be a computer-implemented method and may be stored on a computer-readable data medium. The computer-readable data medium may be transient or persistent, and may be a magnetic, optical, or electric memory, for example, and may be, but is not limited to, a diskette, a magnetic strip, a CD, a DVD, an HDD, an SSD, or a ROM or RAM.

The method or the data processing device may be designed to provide and/or store a calculated position of the conveying device in an image data set. The image data set may preferably be a depiction of the storage places. This allows a user to represent a position of the storage items in the automatic storage system graphically and intuitively in relation to the automatic storage system.

The method and the device thus allow an improvement and increase in efficiency of the human-machine interface, since from the automatic storage system a user obtains information concerning the exact position in the automatic storage system of the conveying device and/or of storage items that are transported by the conveying device.

The storage and/or retrieval point may be designed as a service opening. The service opening is an opening or location that provides a connection from an interior of the storage system to its external surroundings. The service opening may be a simple opening in an enclosure of the storage system. The service opening may also have a shaft-like design, and may be bordered by storage places at the top, bottom, and/or sides. The service opening may also project from the enclosure of the storage system and have additional elements such as one or more tables, one or more dockable transport cars for each of one or more storage items, stored goods carriers, or one or more platforms, which may also be situated outside the enclosure. Lastly, the service opening may also be designed as a completely open transfer area at which stored goods and/or stored goods carriers for the storage and/or retrieval are accepted into or transferred from the storage system.

According to a further embodiment, the method and the device may be designed to directly or indirectly control a robot that automatically approaches a suitable robot position as a function of the actual position and/or the target position and/or the remaining time until reaching the target position.

Direct control takes place when the robot, a conveying device, or a transfer device is controlled directly by the data processing device or the computer-implemented method. Indirect control means that an external control device is prompted by the method and/or the device to perform such a control itself. Of course, the control may also be part of the data processing device or the automatic storage system.

Any type of computer, for example a standard industrial PC, may be used as a data processing device. The data processing device has a processor which may be made up strictly of hardware, strictly of software, or a combination of hardware and software. A CPU, an array processor, a vector processor unit, an ASIC, a GPU, an FPGA, any other processor, and/or an arbitrary combination of these elements may be used as a processor.

The invention is explained below by way of example, based on embodiments with reference to the appended drawings. For the sake of simplicity, the same reference symbols are always used for elements that correspond to one another with regard to function and/or design.

According to the above embodiments, for any of the embodiments described below a feature may be omitted when its technical effect is not relevant for a certain application. Furthermore, according to the above embodiments, features whose technical effect is relevant for a certain application may be added.

### BRIEF DESCRIPTION OF THE DRAWINGS

In the figures:

FIG. 1 shows a schematic sectional illustration of an example of an automatic storage system;

FIG. 2 shows a schematic sectional illustration of an example of a storage system;

FIG. 3 shows a schematic illustration of possible embodiments of the detector;

FIG. 4 shows a schematic illustration of a position-time curve for calculating an actual position of the conveying device and/or of storage items that are transported by the conveying device;

FIG. 5 shows a schematic illustration of the position signal;

FIG. 6 shows a schematic illustration of a further embodiment of the automatic storage system; and

FIG. 7 shows a schematic illustration of the exact positioning in the lift shaft.

### DETAILED DESCRIPTION OF THE PREFERRED EMBODIMENTS

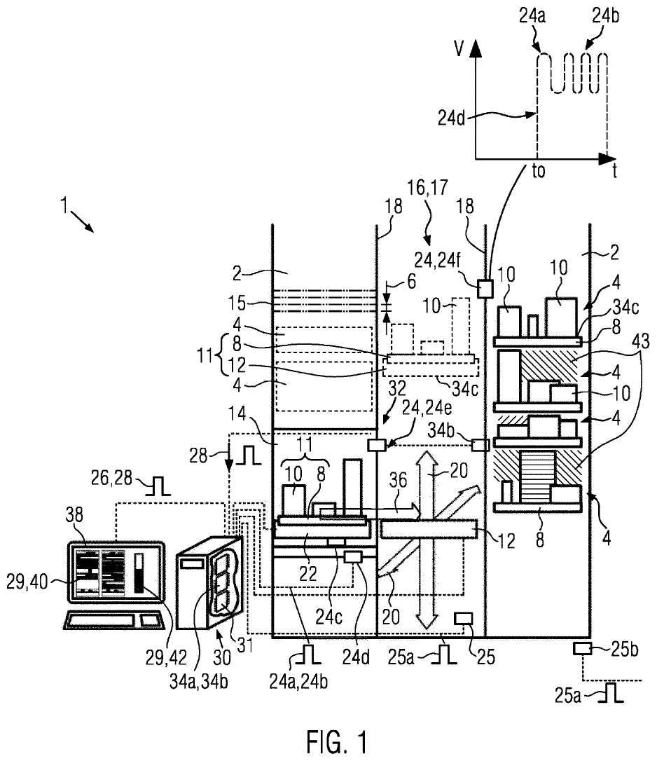

FIG. 1 shows a cross section of an automatic storage system 1. The storage system 1 may include a storage lift as illustrated here by way of example. However, the storage system 1 may also be a horizontal carousel, a vertical carousel (paternoster lift), or a storage system with an aisle conveyor, for example a high rack warehouse or a small parts warehouse.

The storage system 1 may also include a plurality of storage lifts, horizontal carousels, vertical carousels, or aisle conveyors.

This is schematically illustrated in FIG. 6. The storage system 1 shown includes a high rack warehouse 1a with storage lifts 1b, a small parts warehouse 1c, and conveyor belts 1d that connect the high rack warehouse 1a and the small parts warehouse 1c to one another. Situated along the conveyor belts 1d is a robot 1e that is designed to place stored goods 10 on the conveyor belts 1d and remove them from the conveyor belts 1d. In other embodiments, multiple robots may be provided in the storage system. Operating personnel 14a may stow stored goods 10 in the storage system 1 or retrieve them from same at a storage and/or retrieval point 14.

The storage system 1 schematically illustrated in FIG. 1 has a storage area 2 in which storage places 4 arranged one above the other are situated. The storage places 4 may have different heights and may be arranged in a grid spacing 6. A stored goods carrier 8 on which various stored goods 10 can be deposited may be present in a storage place 4. The stored goods carrier 8 and/or the stored good 10 may be referred to as a storage item 11. The storage items 11 may be stationarily situated at a storage place 4, or for storage may be moved toward a storage place 4 and for retrieval may be moved out of a storage place 4. The storage and/or retrieval of the storage items 11 take(s) place along a transport path 17.

The automatic storage system 1 may also have a conveying device 12 that is used to transport a storage item 11 for automatic storage to and/or retrieval from a service opening 14. For a paternoster lift or a horizontal or vertical carousel, the conveying device 12 moves the storage items 11 along a continuously circulating course past the service opening 14, or toward or away from the service opening 14. The service opening 14 connects the storage area 2 to the external surroundings of the automatic storage system 1, and may also be referred to as a storage and/or retrieval point 14.

For a storage lift or an aisle conveyor, the conveying device 12 may move in a storage aisle 16, i.e., along the transport path 17. The storage aisle 16 is provided between two storage racks 18 that are opposite one another with respect to the storage aisle 16. In such a case, the conveying device 12 may be movable, for example, along at least two, preferably mutually orthogonal, spatial directions 20. The conveying device may additionally rotate about a vertical axis (not shown). The storage aisle may represent the transport path 17, or may be part of the transport path 17.

The storage system 1 may have any given number of service openings 14. Individual service openings may be utilized only for storage, only for retrieval, or for both. The service opening 14 may have a shaft-like design. For example, storage places may be present above, below, and/or at the sides of the service opening. However, the service opening may also be a simple opening in an enclosure 15 of the storage system which allows access to the storage area.

The storage system 1 may have a detector 24 that is designed to generate a position signal 24a. In addition, the detector 24 is designed to generate a time stamp 24b, and to provide this time stamp 24b together with the position signal 24a. The time stamp 24b represents a time to of generation of the position signal 24a.

The automatic storage system 1 has a timer module 25 for generating a time signal 25a and/or a timer input 25b for supplying the time signal 25a. The timer module 25 may be a timer module 25 that operates in an incremental or an absolute manner. An incremental timer module 25 supplies a continuous pulse sequence and is designed to count the consecutive pulses. A corresponding time signal 25a may include the number of pulses and a temporal distance between successive pulses, and based on these two values a time period since the beginning of the target operation may be calculated. Alternatively, the time period may be stored in the time signal 25a. A timer module 25 that operates in an absolute manner is designed to provide and/or output an absolute value of a temporal difference from a reference time. For this purpose, the time signal 25a may provide an integer value (128-bit, 64-bit, 32-bit integer).

This allows the automatic storage system 1 to generate the time stamp 24b based on the time signal 25a, and to calculate the position at the other point in time as a function of the time signal.

The detector 24 may have a one-piece design or may be made up of a movable detector element 24c and a trigger element 24d.

In the example in FIG. 1, a detector 24 is situated in a rear portion of the service opening 14, and a further detector 24f is situated along the transport path 17 in the storage shaft 16. The detectors 24 and 24f may be identical or different, for example in their functional principle or their measuring range.

As illustrated in FIG. 1, the position signal 24a is generated at time t₀. In the case shown, a front edge 24d of the position signal 24a corresponds to time t₀. The position signal 24a may be automatically generated by the detector 24 when the conveying device and/or the storage items 11 that are transported by the conveying device pass(es) by the detector or some other predetermined position.

Strictly as an example, the time stamp 24b is encoded with the position signal 24a by pulse modulation or frequency modulation. In other embodiments, the time stamp 24b may be provided and transferred on a separate channel, or subsequently provided and transferred to the position signal 24b. In any case, the time stamp 24b contains the information concerning time t₀, i.e., the information concerning at what point in time the position of a storage item 11 has been detected.

The position signal 24a may be an analog or digital signal that is generated by the detector. Regardless of whether the detector 24 is a contactless detector or a switch or scanner, the position signal 24a may be represented by a change in a voltage (as illustrated in FIG. 1) or a change in a current provided by the detector.

The position signal 24a is schematically illustrated in FIG. 5. The position signal includes position data 72 which may be present in any given encoding, and which represent a position of the conveying device and/or a position of storage items that are transported by the conveying device. The position signal 24a also includes the time stamp 24b.

In some embodiments, the position signal 24a may include further information 74. This information may, for example, be representative of a relative position of the stored good with respect to the stored goods carrier 74a and/or representative of a relative position of the stored goods carrier with respect to the conveying device 74b.

The detector 24 is designed to generate the position signal 24a together with the time stamp 24b, and to output them to a data processing device 30. The data processing device 30 may at the same time be used to control the conveying device 12 and/or the transfer device 22.

The data processing device 30 may be a standard computer, for example a PC. The data processing device has a processor 31, for example a CPU, an ASIC, a VPU, an array processor, or combinations thereof on which software having the function described below is executed. A portion or all functions may also be executed by hardware.

In the exemplary embodiment in FIG. 1, at least a portion of the detector 24 is situated at the end of the service opening 14 facing the storage area 2, or in a transition area 32 between the service opening 14 and the storage area 2.

When a stored goods carrier 8 for storage of stored goods 10 deposited thereon is transported from the service opening 14 in the direction of the storage places 4 by means of the transfer device 22 and/or the conveying device 12, it is transported past the detector 24.

Alternatively or additionally, a detector 24 that is designed as a photoelectric barrier 24e, for example, may be provided in the conveyor shaft 16, i.e., along the transport path 17. The storage items 11 are also led past the photoelectric barrier 24e by means of the conveying device 12 and generate a position signal 24a together with the time stamp 24b. This is indicated by the arrow 36. In the course of this movement, a position signal 24a is generated at successive points in time and thus at various positions along the transport path 17. However, a different time stamp 24b is encoded in the position signal 24a, which has been generated at the photoelectric barrier 24e.

An additional, further detector 24f may also be situated in the transport path 17, in the vicinity of the storage places 4. In another embodiment (not shown), the detector 24 may alternatively or additionally be situated at the conveying device 12 or at a portion of the conveying device 12.

An actual position 34c of the conveying device 12 and/or of the storage item 11 may be calculated from the position signal 24a and the time stamp 24b contained therein or alternatively provided separately, using movement data 34 which may be stored in a memory element 34a. The actual position 34c is illustrated in dashed lines in FIG. 1. After passing by the detector 24, in this case the photoelectric barrier 24e, and after the elapse of a dead time t_{dead}, the storage items 11 are already moved further in the conveyor shaft 16. Nevertheless, the data processing device 30 can calculate an actual position 34c of the conveying device 12 and/or of the storage items 11 by use of the time stamp 24b. Any dead time t_{dead} may be compensated for by the data processing device 30.

The data processing device 30 may be designed to generate remaining time data 26. The remaining time data 26 may be present as a remaining time signal 28. The remaining time data 26 represent a remaining time 29 that is necessary to move the storage item 11 to a target position 34d.

The remaining time data 26, which represent the remaining time 29, may be transferred to a display 38, for example, which may be part of the data processing device 30. The remaining time 29 may be represented in the form of an image 40 or a countdown 42.

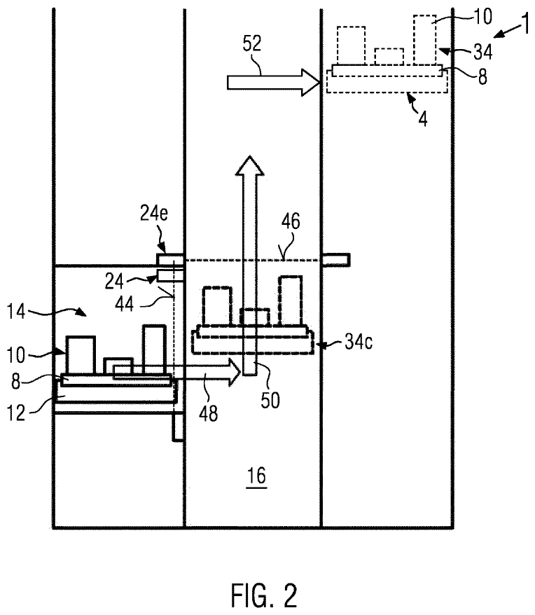

FIG. 2 schematically shows a sectional illustration of an example of a storage system 1.

In the embodiment shown, the stored goods carrier 8 and a stored good 10 are already situated in the service opening 14 on the conveying device 12. The storage takes place along a first direction 48, and in the storage shaft 16 takes place along a second direction 50.

At a first measuring point 44 a detector 24 detects that the conveying device 12 is present at this measuring point, and generates the position signal 24a together with the time stamp 24b. These signals 24a, 24b (as shown in FIG. 1) are transmitted to a data processing device 30. However, until these signals are completely transmitted and evaluated, a certain period of time, the dead time t_{dead}, elapses, within which the conveying device 12 has reached the actual position 34c. Of course, the stored goods carrier 8 and the stored good 10 situated thereon have also reached this actual position 34c; however, it is also possible that only the conveying device 12 is moved through the storage shaft 16, for example to remove a loaded stored goods carrier 10 [sic; 8] from a storage place 4.

Regardless of the dead time t_{dead}, the automatic storage system 1 is able to determine the actual position 34c based on the time stamp 24b.

Also shown is the photoelectric barrier 24e, which during the further movement of the conveying device 12 generates a further position signal 24a and a further time stamp 24b.

In addition, the conveying device 12 may transport the stored goods carrier 8 together with the stored good 10 up to the storage place 4 into a target position 34d. After passing by the photoelectric barrier 24e, the automatic storage system 1 can calculate from the movement data 34 (not shown) at what point in time the stored goods carrier 8 together with the stored good 10 will arrive at the target position 34d. The point in time after which the transport must be delayed may likewise be calculated from the movement data 34. A delay profile may be known (learned). The movement data 34 also include a movement along a third direction 52.

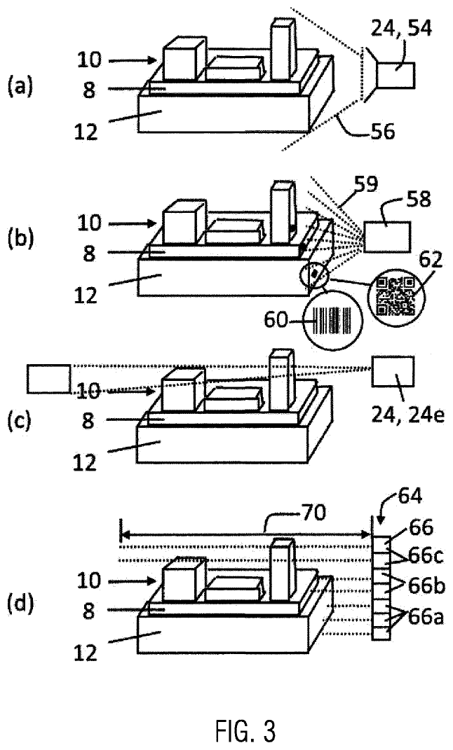

FIG. 3 shows in (a) through (d) a schematic illustration of possible embodiments of the detector 24 in conjunction with the conveying device 12, the stored goods carrier 8, and the stored good 10.

The detector 24 may include a camera 54, for example, which records image data within a recording cone 56. Based on the image data, it is possible to distinguish between the conveying device 12, the stored goods carrier 8, and the stored good 10 and determine their position.

Alternatively, the detector 24 may have a scanner 58 which in a swivel movement (shown in various beams 59) scans a region and reads out either a barcode 60 or a QR code 62, and can thus distinguish between the conveying device 12, the stored goods carrier 8, and the stored good 10. The scanned region may also have a hole pattern and/or one or more color markings.

In a further embodiment, the detector 24, as described above, may be designed as a photoelectric barrier 24e. With this detector it is difficult to distinguish between the conveying device 12, the stored goods carrier 8, and the stored good 10, so that the photoelectric barrier 24e is preferably covered only by the conveying device 12 or by a stored goods carrier 8 that is situated at a fixed position on the conveying device 12. The photoelectric barrier 24e can thus preferably be covered, and thus actuated, only by the conveying device 12 or only by an element that is fixedly installed with the stored goods carrier 8. This allows an unambiguous assignment of the signal generated in front of the photoelectric barrier 24e.

The detector 24 may likewise be made up of a light curtain 64 having a plurality of light sensors 66, each of which detects the presence of an object within a measuring range 70. By suitably selecting the measuring ranges 70, at least one first light sensor 66a may be used only for detecting the conveying device 12, at least one second light sensor 66b may be used only detecting the stored goods carrier 8, and at least one third light sensor 66c having a larger measuring range 70 may be used only for detecting the stored good 10. The measuring range 70 of the different light sensors 66a, 66b, and 66c is indicated by a dashed line.

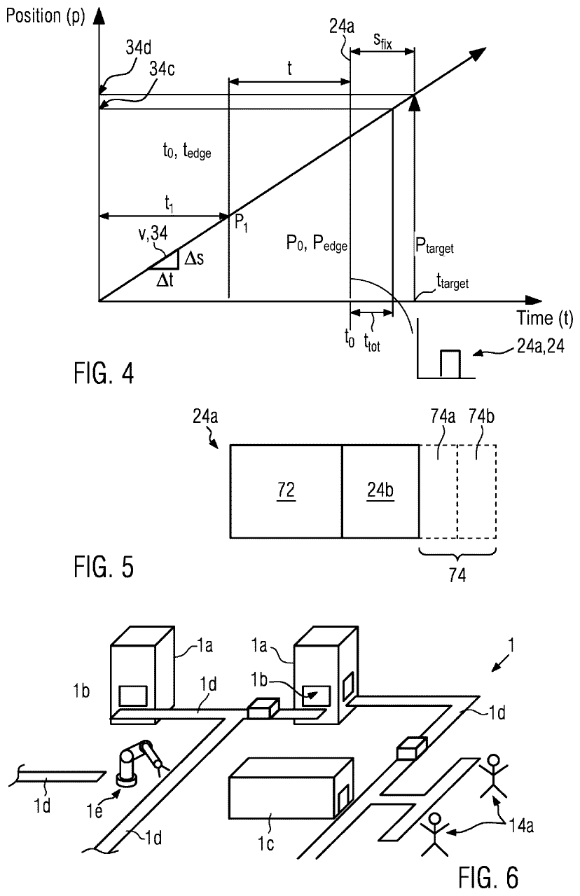

FIG. 4 shows a position-time curve, which may describe the movement of a conveying device 12 or of a storage item 11.

Since the stored good 10 is situated in a relative position with respect to the stored goods carrier 8, and the stored goods carrier 8 is situated in a relative position with respect to the conveying device 12, the position-time curves of the conveying device 12, of the stored goods carrier 8, and of the stored good 10 can differ from one another only at the intersection point of the curve with the position axis, but their ascending slopes cannot differ from one another.

In the position-time curve shown, a speed v of the storage item 11 is assumed to be constant and known. In other embodiments, the position-time curve may also include areas with positive or negative acceleration.

The position signal 24a is generated at time t₀, and as shown in FIG. 1 includes the time stamp 24b. In other embodiments, the time stamp 24b is provided separately from the position signal 24a. Since the speed v of the storage item 11 is known, the actual position 34c can be calculated even when a dead time t_{dead} has elapsed. This is also possible in other embodiments by use of movement data 34 which include areas of negative or positive acceleration. In the shown case, the movement data 34 contain a constant speed v, which in the graphic shown corresponds to the ascending slope.

By use of the movement data 34 it is also possible to calculate when, i.e., at what time t_{target}, a target position 34d is reached.

It is likewise possible to calculate the target position p_{target} based on a predefined time period.

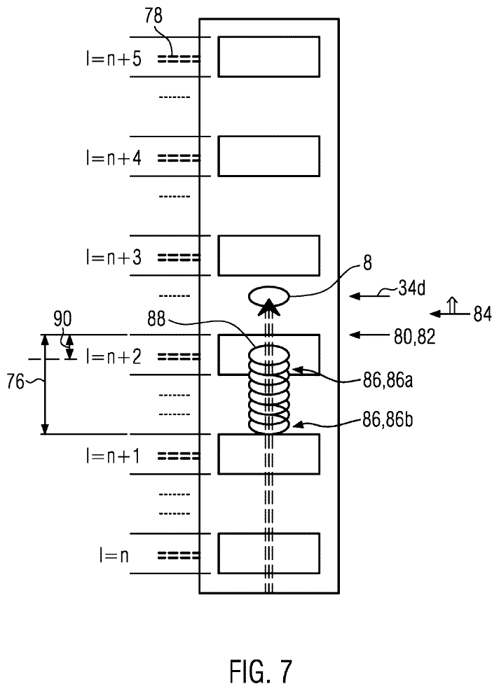

FIG. 7 schematically illustrates how the exact positioning of a stored goods carrier 8 in a lift shaft can take place. A grid spacing 76, which may be 25 mm, for example, is shown. This grid spacing may be defined, for example, by struts 78 (only schematically indicated here by a double line). The point in time when the sensor generates a sensor event as a result of passing by the strut 78 is relevant for the exact positioning. The precise design of the strut 78, for example its geometry, thickness, length, material, etc., is irrelevant for this purpose.

Upon passing by a strut 78, a value may be incremented which roughly represents the position in the storage shaft. When the stored goods carrier 8 (represented by an ellipse) now passes by a strut 78, after this point in time an edge detection may be started. This edge detection detects, for example, an edge 80 in the storage lift, which is used as a relative position 82 for the further movement to the target position 34d.

As soon as the edge 80 has been detected, the stored goods carrier 8 may be moved at a low speed to the target position 34d. This is symbolically illustrated by the relative travel beginning at the edge 84.

If elongation occurs, an actual position 86 is not identical to the computed position 88 that is determined, for example, by the motor for driving the stored goods carrier 8.

When there is slight elongation, the stored goods carrier 8 may be in a first actual position 86a, and with greater elongation may be in a second actual position 86b. Multiple intermediate levels of the elongation, not provided with reference symbols, are also possible.

The edge detection at the edge 80 is preferably started at an increment value I, which may be situated at a predetermined distance 90 from the next strut 78. This distance 90 may be 5 mm, for example. The increment value I is provided strictly as an example of the position of multiple struts 78.

Thus, when a predetermined increment value I is reached, on the one hand the edge detection may be started, and on the other hand the speed of the stored goods carrier 8 may be reduced. In addition, the speed may be reduced upon detection of the edge. The speeds may preferably be further reduced from >1 m/s prior to reaching the strut 78, which is situated in front of the target position 34d, to approximately 0.03 m/s up to the edge 80, and then to approximately 0.005 m/s. These values are strictly examples, and in other embodiments may all or in part be larger or smaller.

### LIST OF REFERENCE SYMBOLS

1 automatic storage system
1a high rack warehouse
1b storage lift
1c small parts warehouse
1d conveyor belt
1e robot
2 storage area
4 storage places
6 grid spacing
8 stored goods carrier
10 stored good
11 storage items
12 conveying device
14 service opening/storage and/or retrieval point
14a operating personnel
15 enclosure
16 storage aisle
17 transport path
18 storage rack
20 spatial direction
22 transfer device
24 detector
24a position signal
24b time stamp
24c detector element
24d trigger element
24e photoelectric barrier
24f further detector
25 timer module
25a time signal
25b timer input
26 remaining time data
28 remaining time signal
29 remaining time
30 data processing device
31 processor
32 transition area between the service opening and the storage area
34 movement data
34a memory element
34c actual position
34d target position
36 arrow
38 display
40 image
42 countdown
44 measuring point
48 first direction
50 second direction
52 third direction
54 camera
56 recording cone
58 scanner
59 beam
60 barcode
62 QR code
64 light curtain
66 light sensor
66a first light sensor
66b second light sensor
66c third light sensor
70 measuring range
72 position data
74 further information
74a relative position of the stored good with respect to the stored goods carrier
74b relative position of the stored goods carrier with respect to the conveying device
76 grid spacing
78 strut
80 edge
82 relative position
84 relative travel beginning at the edge
86 actual position
86a first actual position
86b second actual position
88 computed position
90 fixed distance
I increment value
v speed
t_{dead} dead time
t_{target} target time
t₀ time of detection
p position
p_{target} target position

1. An automatic storage system (1) having at least one storage and/or retrieval point (14) for storage items (11), having at least one detector (24), and having a conveying device (12) for transporting the storage items (11) at least to the at least one storage and/or retrieval point (14), wherein the detector (24) is designed to
detect a position of the conveying device (12) in the storage system (1) and to output a position signal (24a) that is representative of the detected position of the conveying device (12), and
output a time stamp (24b), with the position signal (24a), that is representative of the time (t₀) of detection of the position of the conveying device (12).

2. The automatic storage system (1) according to claim 1, wherein the detector (24) is further designed to detect the position of the moving conveying device (12) in the storage system (1).

3. The automatic storage system (1) according to claim 1, wherein the automatic storage system (1) is designed to calculate, as a function of the position signal (24a) and the time stamp (24b), a position (34c) of the conveying device (12) and/or of a storage item (11) that has been transported by the conveying device (12) at the point in time that is represented in the time stamp, at a different time than the point in time (t₀) that is represented in the time stamp (24b).

4. The automatic storage system (1) according to claim 3, wherein the automatic storage system (1) includes a timer module for generating a time signal and/or a timer input for supplying a time signal, and is designed to calculate the position at the other point in time as a function of the time signal.

5. The automatic storage system (1) according to claim 1, wherein movement data (34) are provided by the automatic storage system (1), and the automatic storage system (1) is designed to calculate, based on the movement data (34), a position in the conveying device (12) at a different time than the point in time that is represented in the time stamp.

6. The automatic storage system (1) according to claim 5, wherein the movement data (34) include at least speed data and/or acceleration data.

7. The automatic storage system (1) according to claim 2, wherein the automatic storage system (1) is further designed to calculate a remaining time (29) until arrival of the conveying device (12) and/or of the storage item (11) that is transported by the conveying device (12) at the point in time represented in the time stamp (24b), at a predetermined location in the automatic storage system (1), and/or a remaining time signal (28) that is representative of the remaining time (29).

8. The automatic storage system (1) according to claim 1, wherein the detector (24) includes at least one IO-Link sensor.

9. The automatic storage system (1) according to claim 1, wherein the detector (24) in the automatic storage system (1) is situated at a location along a transport path (17) for storage items (11).

10. The automatic storage system (1) according to claim 1, wherein the detector (24)
is provided at a conveying device (12) that is movably provided in the automatic storage system (1), or at a storage item (11) that is transported by the conveying device (12), or
is provided at a retaining element that is immovably provided in the automatic storage system (1), on the transport path (17) of the storage items (11), or
has a two-part design, with a detector element (24c) situated at the movable conveying device (12) and/or at the movable storage item (11) that is transported by the conveying device (12), and a trigger element (24d) situated at the immovable retaining element.

11. Use of a detector (24) in an automatic storage system (1) for determining the position of a conveying device (12) and/or of a storage item (11) that is transported by the conveying device (12), wherein the detector (24) is designed to
determine a position of the conveying device (12) and/or of the storage item (11) that is transported by the conveying device (12) and output a position signal (24a) that represents the position of the conveying device (12) and/or of the storage item (11) that is transported by the conveying device (12), and
output a time stamp (24b) with the position signal (24a), which is representative of a time (t₀) of generation of the position signal (24a).

12. A method for detecting the position of a conveying device (12) for transporting storage items (11) in an automatic storage system (1), comprising the method steps:
detecting a position of the conveying device (12) in the storage system (1);
generating a time stamp (24b) that is representative of the time (t₀) of detection of the position of the conveying device (12), and
providing the position signal (24a) together with the time stamp (24b).

13. The method according to claim 12, wherein the position of the conveying device (12) is detected while the conveying device (12) is moving.

14. The method according to claim 12 further comprising providing a computer program product that includes commands which, when the computer program product is executed by a computer, prompt the computer to carry out the method.

15. The method according to claim 14 further comprising providing a computer-readable data medium on which the computer program product is stored.
